(19) United States
(12) Patent Application Publication
(10) Pub. No.: US 2013/0068562 A1
(43) Pub. Date: Mar. 21, 2013

(54) Monitoring Overfilling In An Aeroplane Engine Lubrication System

(71) Applicant: Albert Cornet, Verviers (BE)

(72) Inventor: Albert Cornet, Verviers (BE)

(73) Assignee: TECHSPACE AERO S.A., Herstal (Milmort) (BE)

(21) Appl. No.: 13/605,181

(22) Filed: Sep. 6, 2012

(30) Foreign Application Priority Data
Sep. 20, 2011 (EP) 11181908.2

(51) Int. Cl. F01M 11/10; F16N 29/04; G06F 11/30; F01D 25/18

(52) U.S. Cl. 184/6.4; 701/100

(57) ABSTRACT

The present disclosure relates to lubrication systems for a jet aircraft engine. The system includes an oil tank with a high level sensor and a unit for monitoring the level of oil in a lubricating system. The monitoring unit includes a first input for a high oil level oil level signal, and a second input for a signal that the engine is running, and an output capable of generating an alarm signal. The monitoring unit is configured to generate an overfilling alarm signal, provided that the engine is running and the oil level is equal to or greater than the high level over a given period. This double condition avoids false positives, especially for engines subject to the phenomenon of “gulping”. For these engines the oil level in normal operation is significantly lower than when stopped. These measures can thus provide a reliable means of detecting overfilling.

### CROSS-REFERENCE TO RELATED APPLICATIONS

This application claims the benefit, under 35 U.S.C. §119, of EP 11181908.2, filed Sep. 20, 2011, the disclosure of which is incorporated herein by reference in its entirety.

### FIELD

The teaching relates to a unit for monitoring the oil level in an engine lubrication system, preferably that of an aircraft engine, the lubrication system comprising a tank. The present disclosure also relates to an engine lubrication system, to an engine equipped with a lubrication system, and to a method for monitoring the oil level in a lubrication system.

### BACKGROUND

The statements in this section merely provide background information related to the present disclosure and may not constitute prior art.

Many machines and, more specifically, internal combustion engines, are usually equipped with a lubrication system. These systems essentially comprise a tank containing lubricating oil, at least one pump for circulating or supplying oil and, optionally, oil feed pipes to the different locations requiring lubrication, in particular the bearings.

Overfilling may lead to the oil tank overflowing, causing oil to flow into the engine compartment via an oil breather pipe. This situation is most likely to occur because of overfilling during maintenance. In the case of an aircraft engine, it can also be caused by fuel getting into the oil system in the event of a failure of the heat exchanger between the fuel and the engine lubrication system. In aircraft engines, the oil is often cooled using the fuel. Because of the fuel pressure, which is usually higher than that of the oil, in the event of a failure of the heat exchanger, fuel can leak into the lubrication system and lead to overfilling of the system. This situation is often referred to as “Fuel-in-Oil”. An increase in the volume of lubricating fluid as a result of overfilling can lead to major engine failures, particularly if this situation persists for some time. This failure is difficult to detect with conventional lubricating tank level measuring systems because, on the one hand, of the low accuracy of these systems and, on the other, of the small difference between the normal rest level and the level when overflowing. Consequently this can lead to many false alarms, particularly when the engine is brought to a stop.

In most engines, the lubrication system is often made up of one or more pumps and oilways to feed the various components requiring lubrication. Of these engines, we draw a distinction between so-called dry sump and wet sump engines. In wet sump engines, the oil is held in the crankcase and collected therein by runoff down the walls of the engine, as opposed to dry sump engines in which the oil is collected by scavenge pumps. Engine lubrication systems therefore “consume” a fraction of the volume of available oil in filling the oilways when the engine is running; this fraction is then returned to the sump or tank when the engine stops. This phenomenon is called “gulping” and is even more pronounced in dry sump engines which include scavenge pumps and more oilways.

Aircraft engines are usually dry sump engines, i.e. they comprise a specialized lubrication system with a tank for holding a volume of working oil and scavenge oil that is distributed throughout the engine when it is in operation.

A known solution to the problem of overfilling and the overflow resulting from overfilling is by over-dimensioning the tank and providing various design features to cope with the consequences of overpressure and/or overflow. However, these measures are costly and imperfect to the extent that they do not really solve the problem.

U.S. Pat. No. 5,578,997 relates to a device for detecting fuel vapour in the lubricating oil of a jet aircraft engine. It therefore addresses the problem of fuel leaking into the lubricating oil circuit in the event of a failure of the fuel/lubricating oil circuit heat exchanger, the so-called “Fuel in Oil” problem. The interpretation above discloses an electromechanical device capable of detecting the presence of fuel vapour in the lubricating oil. It consists essentially of a chamber in the oil tank, the chamber comprising a piston and a cartridge located between the piston and the bottom of the chamber, the cartridge comprising a material capable of creating a chemical exothermic reaction, and therefore expanding, in the presence of fuel vapour. In the presence of fuel vapour, the cartridge will move the piston itself which actuates a switch in an alarm circuit. The solution proposed in this interpretation is interesting, but has several drawbacks. Among these are the fact that the material of the cartridge must be replaced after it has reacted, and the production and maintenance cost of the safety device.

Patent EP 0515326 A1 discloses a device for automatically maintaining a constant lubricating oil level in a vehicle with a reciprocating engine. This device is intended primarily for commercial vehicles with very high utilizations. This device essentially comprises a pump controlled by high and low level sensors in the engine housing. A time constant T2 is associated with the high state of the high level sensor and the sensor is then used to stop the pump that compensates for the loss of engine oil. This leveling device is deemed capable of operating under all operating conditions of the vehicle, in particular when the engine is running. This interpretation, however, does not address the problem of detecting overfilling.

U.S. Pat. No. 5,103,648 relates to a measuring device for controlling the oil level in refrigeration system compressors. The device provides an alarm when the level exceeds an upper limit. Just as in the previous interpretation this interpretation is far from the problem of detecting overfilling in a machine or an engine subject to the phenomenon of “gulping”.

### SUMMARY

The present disclosure aims to provide a solution to the problem of overfilling a lubrication system, especially for engines subject to the phenomenon of “gulping”. More particularly, the present disclosure aims to provide a solution to the problem of overfilling an engine lubrication system, including that in a jet aircraft engine, the solution to be simple, inexpensive and reliable.

The invention relates to a unit for monitoring the oil level of an engine lubrication system, preferably that of an aircraft engine, the lubrication system comprising a tank, the unit comprising: a first input capable of receiving a high oil level signal from a level sensor in the oil tank; an output capable of generating an overfilling alarm signal under the condition when a signal from the sensor indicating a high level is received; and a second input capable of receiving a signal that the engine is running and is configured so that a second condition is necessary in order to produce the overfilling alarm signal when the sensor's high oil level signal is present, the second condition being that the engine is running.

This second condition implies, for an engine in good condition, a significant decrease in the level as a result of the “gulping” phenomenon, which makes detection particularly effective because it is based on the impossibility of having a tank close to 100% full while the engine is running.

Preferably, the second condition is limited to the fact that the engine is running.

According to various embodiments of the present disclosure, the first condition requires the receipt of the high oil level signal from the sensor over a given period.

According to various embodiments of the present disclosure, the first condition requires the receipt of the high oil level signal from the sensor continuously over the given period.

According to yet other embodiments of the present disclosure, the period is more than 5 seconds, preferably 10 seconds, more preferably 20 seconds. The period is preferably less than or equal to 60 seconds, more preferably 50 seconds, still more preferably 40 seconds.

According to still yet embodiments of the present disclosure, the second condition includes the fact that the engine is running during the period when the high oil level signal is being received.

In various embodiments, the running condition of the engine corresponds to a speed greater than or equal to 50%, more preferably 75%, of the engine's idling speed. This condition can also correspond to a speed greater than or equal to 50% of the maximum engine speed.

According to various other embodiments of the present disclosure, the monitoring unit comprises a third input capable of receiving a high oil level signal from a supplementary level sensor, the first condition comprises receiving high oil level signals from both the first and the third sensors respectively. The supplementary level sensor can be of the type capable of detecting a single level.

The present disclosure also relates to an engine lubrication system, in particular one in an aircraft engine, the lubrication system comprising: a tank for containing oil, an oil high oil level sensor in the tank, a unit monitoring the lubricating system oil level; wherein the monitoring unit is according to the present disclosure.

According to various embodiments, the tank includes a top portion, located above its highest fluid level, containing an air outlet capable of being connected to an engine housing.

The present disclosure also relates to an engine equipped with a lubrication system, wherein the system is according to the present disclosure.

According to various embodiments, the engine is such that it absorbs a fraction of the volume of oil from the lubricating system when running, the oil fraction flowing back into the tank when the engine is brought to a stop. The oil fraction is preferably between 10% and 50% of the total oil volume, more preferably between 20% and 40% of the total oil volume. The fraction of the oil consumed temporarily during operation of the engine depends on the engine speed, more generally increasing as the engine speed rises.

The present disclosure further relates to a method for monitoring the oil level of an engine lubrication system, preferably that of an aircraft engine, the method comprising the following stages: (a) monitoring the oil level in the tank in relation to a high level; (b) emitting an overfilling alarm signal in the presence of a first condition corresponding to an oil level in the tank greater or equal to the high level; wherein step (b) comprises a second condition for generating the overfilling alarm signal, the second condition being that the engine is running.

According to various embodiments of the present disclosure, the first condition requires that the oil level is greater than or equal to the high level over a given period.

According to yet other embodiments of the present disclosure, the period is greater than 5 seconds, preferably 10 seconds, more preferably 20 seconds. The period is preferably less than or equal to 60 seconds, more preferably 50 seconds, still more preferably 40 seconds.

Features of the present disclosure provide a reliable alarm function capable of preventing overpressure and/or tank overflow. In fact overflow conditions can be detected well before they occur. The features of the present disclosure are simple, inexpensive and easy to implement. Positioning the high level detector above the level that is normal during engine operation makes the measurements reliable, avoiding false positives during natural level variations relative to the normal level.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a schematic illustration of an aircraft engine lubrication system and monitoring unit, in accordance with various embodiments of the present disclosure.

FIG. 2 is a detailed illustration of an oil tank and the lubrication system monitoring unit shown in FIG. 1, in accordance with various embodiments of the present disclosure.

FIG. 3 is a flowchart illustrating the principle of operation of the monitoring unit shown in FIG. 1, in accordance with various embodiments of the present disclosure.

FIG. 4 is an illustration of the state of the oil tank in the lubrication system during normal engine operation, in accordance with various embodiments of the present disclosure.

FIG. 5 is an illustration of the state of the oil tank in the lubrication system during normal engine operation, in accordance with other embodiments of the present disclosure.

FIG. 6 is an illustration of the state of the oil tank in the lubricating system in an overflow situation in the absence of overfilling having been detected, in accordance with various embodiments of the present disclosure.

FIG. 7 is an illustration of the state of the oil tank in the lubrication system in an overflow situation with overfilling having been detected in accordance with the invention in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

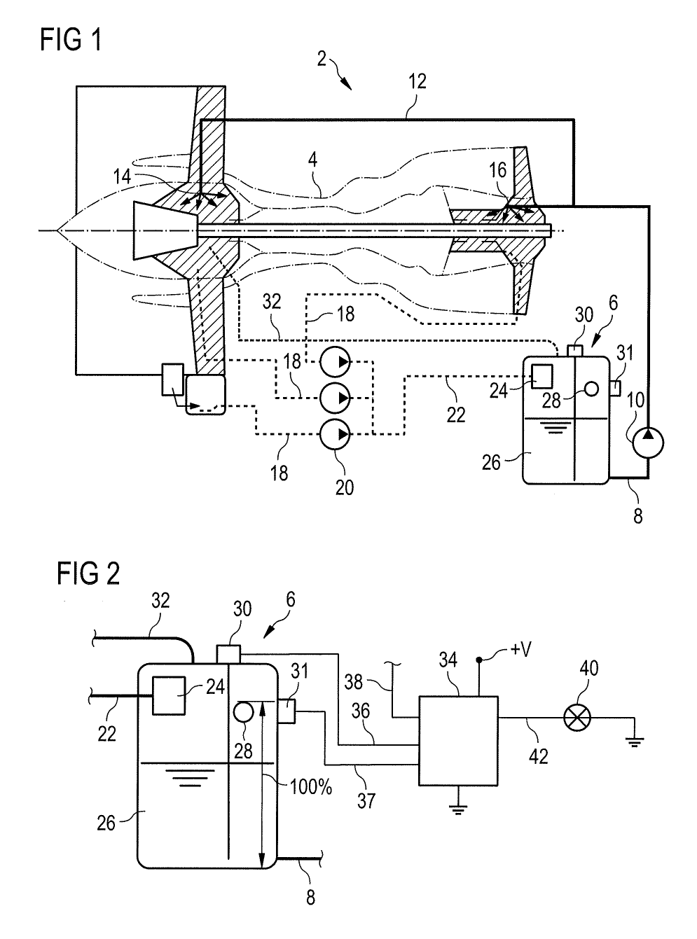

FIG. 1 shows a lubrication system for an aircraft engine 4. The lubrication system 2 generally comprises an oil tank 6, and an outlet pipe 8 connected to a feed pump 10. Feed pipes 12 carry oil from the pump to different housings 14 and 16 at the front and rear of the engine 4 containing bearings to be lubricated. The oil is then recovered from the bottom of these housings via scavenge pipes 18 and one or more scavenge pumps 20. This oil containing dissolved air is then routed via pipe 22 to the tank 6. The tank 6 comprises a chamber 26 with an air/oil separator 24 located in an upper part of the chamber 26 and connected to the oil return pipe 22. The tank 6 also includes a normal level visual inspection window 28, a level detector 30 and a supplementary level detector 31. The level detector, or sensor, 30 may comprise a movable float mounted on a rod immersed in the tank, the float comprising a magnetized part interacting with reed switches distributed along the rod. The supplementary level detector 31 may be of the discrete type, that is to say capable of detecting one level only, namely a high level. The upper part of the chamber 26 of the tank 6 is also connected via an oil breather pipe 32 to one or more housings 14 and 16 of the engine, in order to allow the removal of air from the scavenge pumps, this air then being separated from the oil.

The feed and scavenge pumps 10 and 20 are preferably of the volumetric type and driven by the main engine shaft. When the engine 4 is stopped the oil in the lubrication housings 14 and 16 and the feed and scavenge pipes 12 and 18 flows back into the tank 6.

FIG. 2 shows the tank 6 of the lubrication system 2 and an oil level monitoring unit 34 for that system. The monitoring unit 34 is electrically powered and comprises a primary input 36 connected to the output of the tank level sensor 30. The monitoring unit 34 also includes a secondary input 38 connected to a transmitter signal of the engine. In various embodiments, the monitoring unit 34 can include a third input 37 connected to the supplementary level sensor 31. The third input 37 provides redundant information on the high level in the tank 6 and therefore adds reliability. The monitoring unit 34 comprises an output 42 capable of generating a control signal to an alarm 40. The alarm 40 can be visual, aural or in any other standard form.

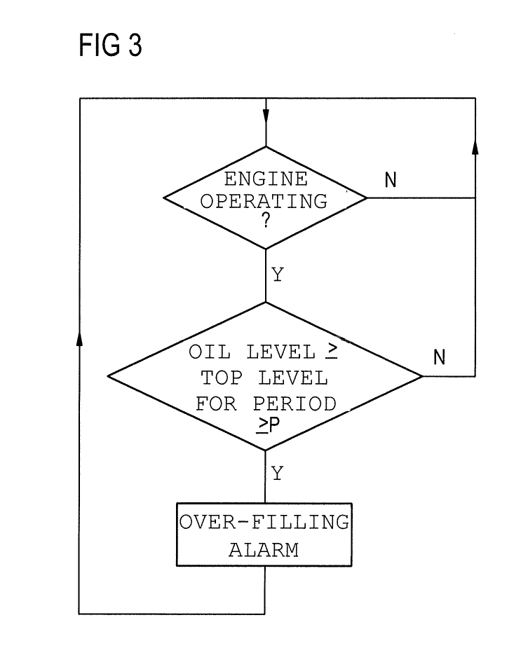

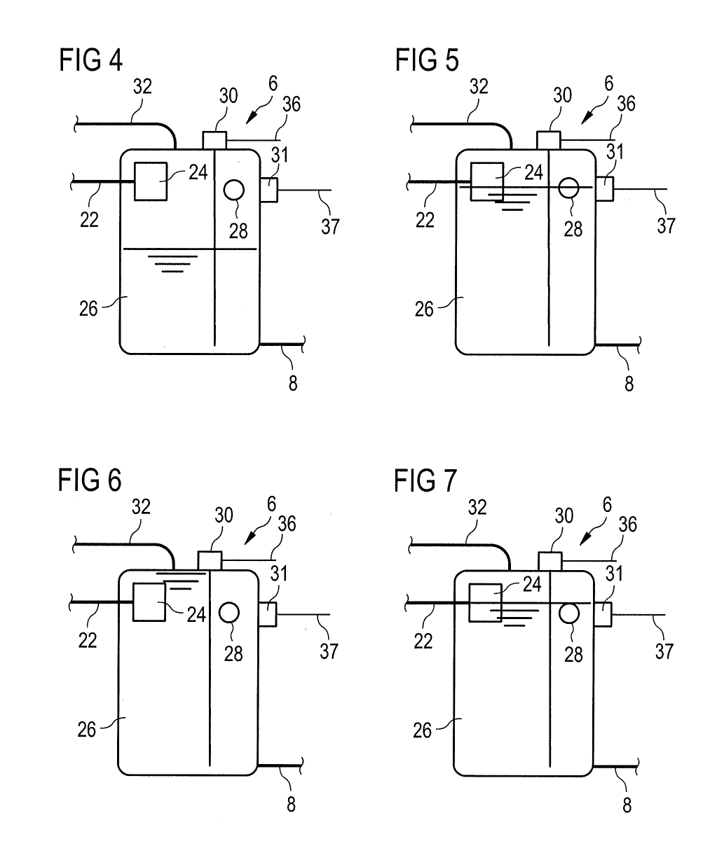

FIG. 3 illustrates the operation of the logic of the lubrication system oil level monitoring unit 34. The monitoring unit 34 verifies that two conditions have been met before producing an overfilling alarm signal. The monitoring unit 34 checks whether the engine is running and the oil level is higher than or equal to the high level over a given period P. Indeed, it is only when the engine is running that overfilling is significant, as will be explained in more detail in connection with FIGS. 4-7. In addition, the act of observing the presence of the high oil level signal over a given period can make measurements far more resistant to any possible temporary level fluctuations, such as may be due to vibration, gravity inversion (air pockets), or abrupt aircraft maneuvers. This period can be of the order of a few seconds to the order of a few minutes. In various embodiments, this period is between 10 and 60 seconds.

FIG. 4 shows the tank 6 during normal engine 4 operation. Part of the oil in the lubrication system is in the engine 4 and the oilways. The oil level in the chamber 26 of the tank 6 represents a fraction of the volume of the chamber 26. In the specific case of the example in FIG. 4, this level represents approximately 50% of the capacity of the chamber 26, on the assumption that this value is given as an example only. The level detectors 30 and 31 produce no high oil level signals.

FIG. 5 shows the tank 6 when the engine 4 is stopped. Stopping the engine 4 allows the oil in the oilways and the lubricated bearing housings 14 and 16 to run back into the tank 6. The level of the tank 6 in FIG. 5 is substantially higher than that in FIG. 4 when the engine 4 is running. However, the level is slightly lower than the high level corresponding to 100% of the tank 6 capacity. As in the configuration of FIG. 4, the level detectors 30 and 31 produce no high oil level signals.

FIG. 6 shows the tank 6 in an overflow situation which is precisely the situation to avoid. For various reasons, such as the leakage of fuel into the oil mentioned above (“Fuel-in-Oil”) or simple overfilling, the amount of oil in the lubrication system is too great, to the extent that the chamber 26 of the tank 6 is completely or almost completely filled and part of the oil flows through the oil breather pipe 32 to an engine housing 14 and/or 16. This can happen both when the engine 4 is running and when it is stopped. The surplus oil flow to an engine housing 14 and/or 16 can have serious consequences on the functioning of the latter. The presence of oil in a housing 14 and/or 16 can potentially cause damage by contaminating parts of the engine 4, as well as causing uncontrolled combustion, or even causing a fire in the engine 4.

FIG. 7 shows the tank 6 in a situation when overfilling has been detected by the lubrication system 2 of the invention. Indeed, the level has reached or exceeded the high level either continuously or sporadically over a given period but repeatedly over that period when the engine is running. This detection means that the tank 6 is likely to overflow. The alarm will then allow the pilots of the aircraft and/or maintenance personnel to take any necessary action.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A unit for monitoring the oil level of an engine lubrication system, preferably that of an aircraft engine, the lubrication system comprising a tank, the monitoring unit comprising:
a first input capable of receiving a high oil level signal from an oil level sensor in the tank;
an output capable of generating an overfilling alarm signal when a first condition is satisfied comprising receiving a high oil level signal from the sensor on the first input; and
at least a second input capable of receiving a signal indicating the engine is running, and is configured so that a second condition is satisfied to produce an overfilling alarm signal, the second condition comprising receiving from the second input a signal indicating the engine is running.

2. The monitoring unit according to claim 1, wherein the first condition requires the receipt of the high oil level signal from the sensor over a given period.

3. The monitoring unit according to claim 2, wherein the first condition requires the receipt of the high oil level signal from the sensor continuously over the given period.

4. The monitoring unit according to claim 3, wherein the period is greater than 5 seconds, preferably 10 seconds, more preferably 20 seconds.

5. The monitoring unit according to claim 4, wherein the period is less than 60 seconds, preferably 50 seconds, more preferably 40 seconds.

6. The monitoring unit according to claim 5, wherein the second condition comprises the fact that the engine is running while the high oil level signal is being received.

7. The monitoring unit according to claim 6, wherein the monitoring unit comprises a third input capable of receiving a high oil level signal from a supplementary level sensor, wherein the first condition comprises receiving high oil level signals from both the first and the third sensors respectively.

8. A lubrication system of an engine, particularly an aircraft engine, said lubrication system comprising a tank and a monitoring unit, wherein said monitoring unit comprises:
a first input capable of receiving a high oil level signal from an oil level sensor in the tank;
an output capable of generating an overfilling alarm signal when a first condition is satisfied comprising receiving a high oil level signal from the sensor on the first input; and
at least a second input capable of receiving a signal indicating the engine is running, and is configured so that a second condition is satisfied to produce an overfilling alarm signal, the second condition comprising receiving from the second input a signal indicating the engine is running.

9. The lubrication system according to claim 8, wherein the tank comprises a top portion located above its highest fluid level, containing an air outlet for connection to a housing of the engine.

10. An engine equipped with a lubrication system, wherein the lubrication system comprises a tank and a monitoring unit, said monitoring unit comprising:
a first input capable of receiving a high oil level signal from an oil level sensor in the tank;
an output capable of generating an overfilling alarm signal when a first condition is satisfied comprising receiving a high oil level signal from the sensor on the first input; and
at least a second input capable of receiving a signal indicating the engine is running, and is configured so that a second condition is satisfied to produce an overfilling alarm signal, the second condition comprising receiving from the second input a signal indicating the engine is running.

11. The engine according to claim 10, wherein the engine is such that it absorbs a fraction of the lubricating system's volume of oil when in operation, the oil fraction flowing back to the tank when it is stopped.

12. A method for monitoring the oil level of a lubrication system of an engine, preferably of an aircraft engine, the lubrication system comprising a tank, the method comprising the following steps:
(a) monitoring the oil level in the tank in relation to a high level;
(b) emitting an overfilling alarm signal in the presence of a first condition corresponding to an oil level in the tank greater than or equal to the high level;
wherein step (b) comprises a second condition for generating the overfilling alarm signal, the second condition comprising the fact that the motor is running.

13. The method according to claim 12, wherein the first condition requires the oil level is greater than or equal to the high level over a given period.

14. The method according to claim 13, wherein the period is greater than 5 seconds, preferably 10 seconds, more preferably 20 seconds.

15. The method according to claim 14, wherein the period is less than 60 seconds, preferably 50 seconds, more preferably 40 seconds.
